(19) United States
(12) Patent Application Publication
(10) Pub. No.: US 2018/0341687 A1
(43) Pub. Date: Nov. 29, 2018

(54) IDENTIFYING THE SUBJECT OF AN AMBIGUOUS NAME IN A COMMUNICATION

(71) Applicant: INTERNATIONAL BUSINESS MACHINES CORPORATION, Armonk, NY (US)

(72) Inventors: James E. Bostick, Cedar Park, TX (US); John M. Ganci, JR., Cary, NC (US); Martin G. Keen, Cary, NC (US); Sarbajit K. Rakshit, Kolkata (IN)

(21) Appl. No.: 15/603,691

(22) Filed: May 24, 2017

(51) Int. Cl. G06F 17/30; H04L 29/06; G06N 5/02

(52) U.S. Cl. CPC G06F 17/30542; G06N 5/02; H04L 63/0421; G06F 17/30864

(57) ABSTRACT

Systems and methods for identifying a subject of an ambiguous name in a communication are disclosed. In embodiments, a computer-implemented method, includes: receiving historic communication data of a first person from a first remote computing device; receiving historic communication data of a second person from a second remote computing device; generating a knowledge database includes contact data for both the first person and the second person mapped to third party data, including informal and formal names of one or more third parties referenced in the historic communication data of the first person and the historic communication data of the second person; receiving a query regarding an ambiguous name referenced in a new communication between the first person and the second person; and determining a match between the ambiguous name and an informal name or a formal name in the knowledge database.

### BACKGROUND

The present invention relates generally to identification of subject matter in communications and, more particularly, to identifying the subject of an ambiguous name in a communication.

Different digital communications methods are increasingly used in private and professional settings to communicate. Often, digital communications are less formal, referring to one or more persons by only a single name or nickname. Such references may be ambiguous to a user receiving such a message. Such communications may be relayed over various computer devices, such as smartphones, tablet computers, laptop computers, desktop computers, and others. Often digital communications are conducted through internet-based networking systems (e.g., social networking sites) or on-site networking systems (e.g., corporate networks) designed to enable communication amongst a plurality of participants.

### SUMMARY

In an aspect of the invention, a computer-implemented method includes: receiving, by a computing device, historic communication data of a first person from a first remote computing device; receiving, by the computing device, historic communication data of a second person from a second remote computing device; generating, by the computing device, a knowledge database comprising contact data for both the first person and the second person mapped to third party data, including informal and formal names of one or more third parties referenced in the historic communication data of the first person and the historic communication data of the second person; receiving, by the computing device, a query regarding an ambiguous name referenced in a new communication between the first person and the second person; and determining, by the computing device, a match between the ambiguous name and an informal name or a formal name in the knowledge database.

In another aspect of the invention, there is a computer program product for identifying a subject of an ambiguous name in a communication. The computer program product comprises a computer readable storage medium having program instructions embodied therewith. The program instructions are executable by a computing device to cause the computing device to: receive historic communication data of a first person from a first remote computing device; receive historic communication data of a second person from a second remote computing device; generate a knowledge database comprising contact data for both the first person and the second person mapped to third party data, including informal and formal names of one or more third parties referenced in the historic communication data of the first person and the historic communication data of the second person; receive a query regarding an ambiguous name referenced in a new communication between the first person and the second person; determine a match between the ambiguous name and a formal name associated with a contact of the sender; and send an answer to the query identifying the subject of the ambiguous name.

In another aspect of the invention, there is a system for identifying a subject of an ambiguous name in a communication. The system includes a CPU, a computer readable memory and a computer readable storage medium associated with a computing device; program instructions to receive historic communication data of a first person and historic communication data of a second person; program instructions to generate a knowledge database from the received historic communication data of the first person and the received historic communication data of the second person, the knowledge database including a first data set comprising contacts of the first person mapped to formal names and informal names of one or more third parties, as well as counts of the occurrences of the informal names in the historic communications, and a second data set comprising contacts of the second person mapped to formal names and informal names of one or more third parties, as well as counts of the occurrences of the informal names in the historic communications; and program instructions to receive a query from a recipient of a new communication to identify a third person who is a subject of an ambiguous name referenced in the new communication; program instructions to determine a formal name or an informal name of the third person who is a subject of the ambiguous name using the first data set and the second data set, wherein the determination is made based in part on the counts; and program instructions to send the formal name or the informal name of the third person to a computing device of the recipient of the new communication in response to the query; wherein the program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a computing infrastructure according to an embodiment of the present invention.

FIG. 2 shows an exemplary environment in accordance with aspects of the invention.

FIG. 3 shows a flowchart of steps of a method in accordance with aspects of the invention.

FIG. 4 shows a flowchart of steps of a method in accordance with aspects of the invention.

FIG. 5 depicts an exemplary use scenario in accordance with embodiments of the invention.

### DETAILED DESCRIPTION

The present invention relates generally to identification of subject matter in communications and, more particularly, to identifying the subject of an ambiguous name in a communication. When communicating via different communications platforms (e.g., social media, e-mail, instant messages, text message, etc.), it may be difficult for a recipient or viewer of a communication to understand or identify a subject or individual to which the sender of a communication is referring. For example, a sender may refer to a subject or individual in a communication using a nickname, handle, etc., or other ambiguous identifier that may not be recognizable by the viewer or recipient of the communication. Accordingly, aspects of the present invention may identify a “non-ambiguous” name of an individual referred to in a communication.

In embodiments, a user computer device gathers data regarding various interactions between participants in such a way that the user computer device understands names associated with each participant (e.g., first name, last name, middle name, nickname, handle, moniker, etc.) when referring to their social connections (e.g., friends, family and acquaintances) in a digital communication. In aspects, a knowledge base stores each relationship for every participant with a count of times that the participant refers to a social connection by a particular name. In embodiments, the knowledge base is utilized to track name usage and social connection information (e.g., who knows who), which is utilized to determine whom an author of an ambiguous digital communication (e.g., text message, email, instant message, etc.) is likely referring to. In aspects, the user computer device uses the knowledge base to determine percentages of name usage (e.g., the nickname “Jimmy” is used 70% of the time by participant A). The determined percentages may be utilized in real time probability calculations to determine whom a participant is referring to in a digital communication. In aspects, systems of the invention increase the knowledge base over time, thereby improving the probability of determining correct name usage as more input data is added to the knowledge base.

In a world of networked electronic communications, receiving an ambiguous name in a communication is increasingly common, particularly when an electronic communication is a group communication sent to more than one recipient. Embodiments of the invention address the problem of receiving an ambiguous name in an electronic communication by gathering electronic communication data from both the sender and the receiver of the electronic communication at issue, and analyzing third part data within the sender's and receiver's data to determine the most likely person who is being referenced using the ambiguous name. Embodiments of the invention provide a remote server that can protect the privacy and integrity of communication information (e.g., contacts) of the sender and receiver, while also enabling determinations of relationships and matches between contacts of the sender and receiver. For example, a recipient of a communication will not be provided with details regarding the person associated with the ambiguous name if the recipient does not know the person (e.g., the recipient does not list the person as a contact of theirs in a database). The present invention also reduces computer overhead (i.e., consumption of computing resources) by enabling an identification server to provide a common knowledge database to multiple user computer devices. Moreover, embodiments of the invention improve the communications operations of a user computer device by adding to the functionality of one or more communication methods utilized (e.g., automatically displays an informal name to the recipient within an electronic messaging communication).

Advantageously, a system of the invention may also provide for understanding all formal participant connections from various sources for any given resource including social media, messaging, texting, phone conversations and contacts through an interface with each source (e.g., user computer devices and third party servers) by which to pipe formal user contacts in standard form (e.g., Extensible Markup Language (XML)) to an identification server. In embodiments, the identification server is configured to understand the connections and what participants call one another through a cyclically run process, and recall this understanding instantaneously from the knowledge database. Further, in embodiments the system is configured to process and understand how one person refers to another person for some percentage of time (all of which may be ambiguous references to another user) through natural language processing (NLP) classification techniques to find names used in communications (e.g., messages) while figuring out who the ambiguous name is referring to, and storing each with a count (and thus percentage of usage).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

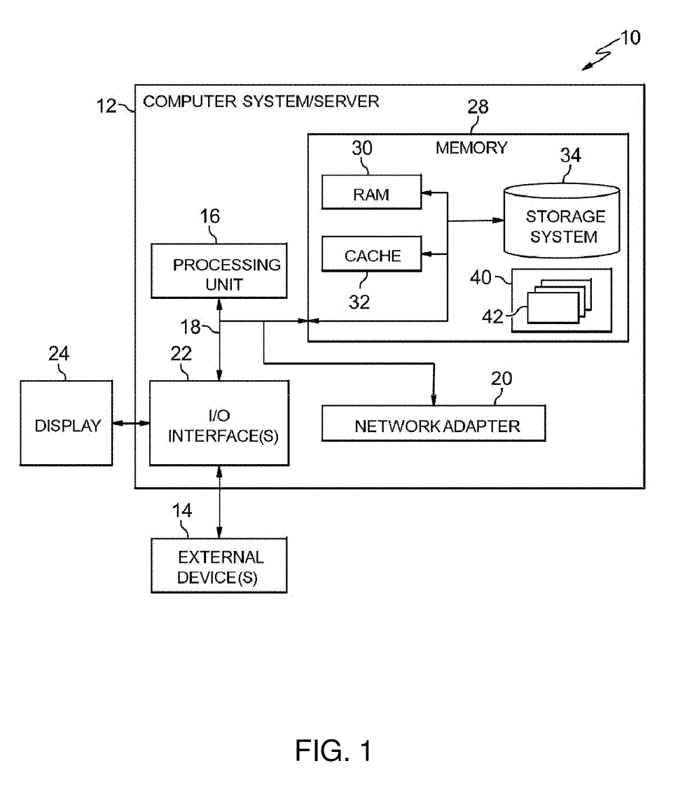

Referring now to FIG. 1, a schematic of an example of a computing infrastructure is shown. Computing infrastructure 10 is only one example of a suitable computing infrastructure and is not intended to suggest any limitation as to the scope of use or functionality of embodiments of the invention described herein. Regardless, computing infrastructure 10 is capable of being implemented and/or performing any of the functionality set forth hereinabove.

In computing infrastructure 10 there is a computer system (or server) 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computing infrastructure 10 is shown in the form of a general-purpose computing device. The components of computer system 12 may include, but are not limited to, one or more processors or processing units (e.g., CPU) 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

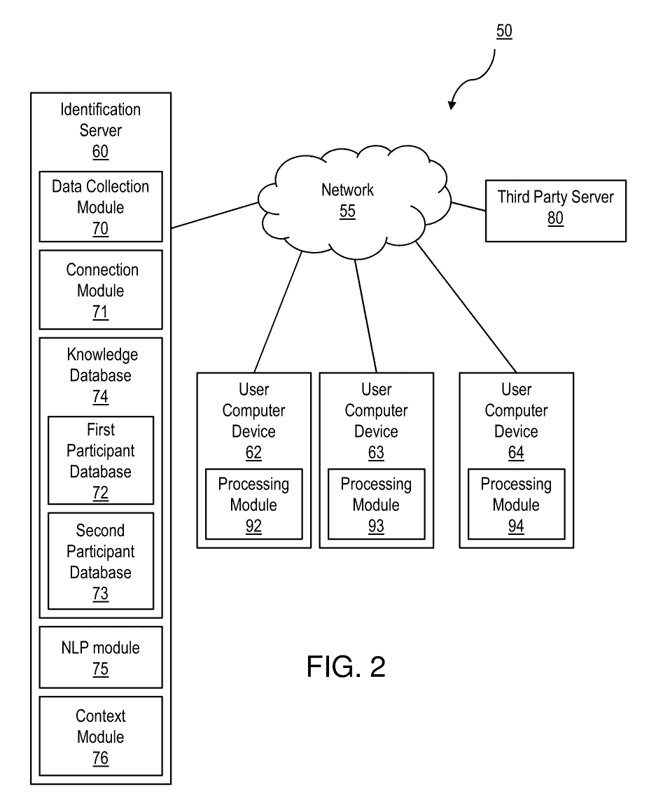

FIG. 2 shows an exemplary environment in accordance with aspects of the invention including an identification system generally indicated at 50. The environment includes an identification server 60 connected to a network 55. The identification server 60 may comprise a computer system 12 of FIG. 1, and may be connected to the network 55 via the network adapter 20 of FIG. 1. The identification server 60 may be configured as a special purpose computing device that is part of communications infrastructure. For example, the identification server 60 may be configured to receive communications data from one or more user computer devices represented at 62-64 via the network 55. In embodiments, the identification server 60 is configured to identify an ambiguous name referenced in a new communication. As used herein, the term ambiguous name refers to a name that is unclear or open to more than one interpretation by a reader, with respect to the person the ambiguous name is intended to refer to. For example, a reference to the name “John” in a communication may be ambiguous since a reader may know of several persons with the name “John”, and it may be unclear which “John” is being referred to by the sender of the communication. It should be understood that the term non-ambiguous name as used herein describes a name that is not unclear or open to more than on interpretation by a reader, with respect to the person the ambiguous name is intended to refer to. For example, the name “John” may be ambiguous to a reader while the name “John Doe” is not ambiguous. The identification server 60 may identify an ambiguous name based on: formal participant connections from various sources of a given resource (e.g., social media, messaging, texting, phone conversations and contacts); how one person refers to another person for some percentage of time; and how to narrow down possible reference points through further classification based on the context in which the person is speaking to the recipient (e.g., subject matter of conversation).

In embodiments, the identification server 60 includes one or more modules configured to perform one or more of the functions described herein, the one or more modules including one or more program modules (e.g., program module 42 of FIG. 1) executed by the identification server 60. In aspects, the identification server 60 includes a data collection module 70 for collecting data from the one or more user computer devices 62-64. In embodiments, the identification server 60 includes a connection module 71 for determining contacts from the data collected by the data collection module 70 for each participant, and storing the contact data in respective participant databases (e.g., first participant database 72, second participant database 73, etc.) of a knowledge database 74. In aspects, the identification server 60 includes a natural language processing (NLP) module 75 configured to process the communication data received by the data collection module 70 to determine the use of one or more names associated with a person who is the subject of a communication, and for associating the one or more names with the person in the knowledge database 74. In embodiments, the identification server 60 includes a context module 76 configured to determine subject matter relationships between participants and contacts stored in the knowledge database 74.

The network 55 may be any suitable communication network or combination of networks, such as a local area network (LAN), a general wide area network (WAN), and/or a public network (e.g., the Internet). Each user computer device 62-64 may be a general purpose computing device, such as a desktop computer, laptop computer, tablet computer, smartphone, smartwatch, etc. Each user computer device 62-64 may include one or more components of the computer system 12, including, for example, one or more program modules 42. In embodiments, each user computer device 62-64 includes a respective processing module 92-94 for communicating with the identification server 60 and identifying correlations between one or more names of persons in the knowledge database 74 with one or more names of persons mentioned in a digital communication. In embodiments, each user computer device (e.g., 62) may be in communication with other user computer devices (e.g., 63) as well as one or more third party servers 80, such as social media servers, via the network 55.

System 50 may be practiced in distributed cloud computing environments, and the user computer devices 63-64 may be cloud computing nodes utilized by cloud consumers. In such a distributed cloud environment, the identification server 60 may offer infrastructure, platforms and/or software as a service for which a cloud consumer does not need to maintain resources on a location computing device.

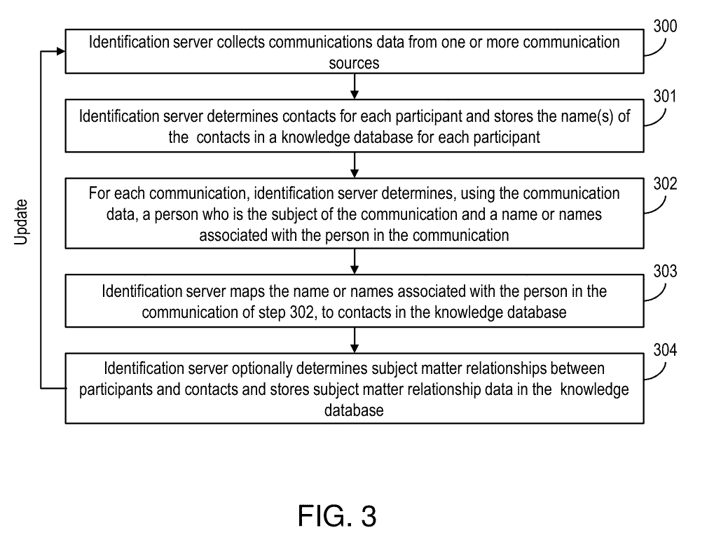

FIG. 3 shows a flowchart of a method for collecting and mapping communication data in accordance with aspects of the invention. Steps of the method of FIG. 3 may be performed in the environment illustrated in FIG. 2, and are described with reference to elements shown in FIG. 2.

At step 300, the identification server 60 collects historic communication data from historic communications obtained from one or more communications sources for each participant user. Data collected may be stored in a database (not shown) of the identification server 60 for further processing. In embodiments, data collected by the identification server 60 is stored in XML format. In aspects, the data collection module 70 of the identification server 60 is in communication with a plurality of user computer devices (e.g., 62-64) of participants, as well as one or more third party servers 80. In embodiments, the identification server 60 obtains communication data from processing modules (e.g., 92-94) of user computer devices (e.g., 62-64). Historic communication data collected by the identification server 60 may include data from multiple communication sources, such as data from social media software, instant messaging software, text messaging software, email software, audio communications (e.g., telephone conversation transcripts), etc. Such communications data may include, for example, text-based communications or text-based transcripts of communications conducted utilizing a user computer device 62-64. For example, the identification server 60 may collect social media communication data from the third party server 80 via the network 55, or may collect social media communication data from the user computer devices 62-64 via the network 55.

Historic communication data may be collected on a continuous or periodic basis. In embodiments, streams of e-communication data are collected from multiple sources (e.g., user computer devices 62, 63, 64 and third party server 80) on an ongoing basis, where the e-communication data is in the form of an email, text message, instant message, social network message, telephone call (or other sound messages), images or picture-based messages, etc. In the case of sound messages, the identification server 60 may include speech recognition software to convert sound messages into text based messages. Likewise, in the case of image messages, the identification server 60 may include text recognition software to recognize and convert images into text based messages.

In embodiments, a participant or user may determine which communications information will be shared with the identification server 60. In aspects, participants may register with the identification server 60 and provide the identification server 60 with rules and/or permission determining when or if the identification server 60 may access the participant's communication information. In embodiments, a user will set rules at the processing module (e.g., 92) of the user computer device (e.g., 62), wherein the rules determine which communication information is provided to the identification server 60 by the user computer device (62). In aspects, the system 50 allows participants (e.g., through a graphical user interface) to specify various social sites (e.g., third party server 80) as one form of input, where the system 50 in configured to analyze the participants' social media connections to understand who the participant may know. The system 50 may also be configured to use streams of data collected from the social site in time cycles, in order to determine what name the participant is calling another person as he or she is directly talking to that person.

Still referring to FIG. 3, at step 301, the identification server 60 determines contacts from the historic communication data collected at step 300 for each participant and stores the name(s) of the contacts in respective participant databases (e.g., 72, 73) in the knowledge database 74. In embodiments, the connection module 71 of the identification server 60 determines contacts for each participant on a continuous or periodic basis. The name or names of each contact determined at step 301 may include formal names or nicknames. As used herein, the term formal name refers to a participant's preferred or primary name, such as a participant's given name, full legal name, the name registered with the system 50, the name registered with a third party (e.g., social media server) or a name by which the user typically goes by. As used herein, the term informal name refers to a nickname or other names other than the formal name by which the participant may be called or may go by.

The identification server 60 may obtain communications data from a user computer device 62 in the form of a contact list at step 300, and the identification server 60 may determine the names of contacts from the contact list and store the names of the contacts in the knowledge database 74. In another example, the identification server 60 may determine the names of contacts of a participant based on the participant's communications (e.g., contact data, such as a formal name, may be taken from sender information in the communication). In embodiments, the connection information may include participant connection information compiled by a user computer device (e.g., 62), third party server 80, or other device, and collected by the identification server 60. For example, Richard Roe's social network contacts from a social media network may be stored as contacts in the first participant database 72, along with contacts from Richard Roe's email system.

In embodiments, the identification server 60 continuously or periodically compares a participant's contacts from newly collected communications data (e.g., contact lists from email servers, social network sites, telephone, communications, etc.) to contact data currently in the knowledge database 74. New contacts not already present in the knowledge database 74 are then added. In embodiments, contact in the knowledge database 74 that are no longer listed in the contact data of a user (gathered at step 300) may be removed from the knowledge database 74. In this way, the knowledge database 74 may be continuously updated for multiple participant's to provide participant's of the system 50 with the up-to-date contact information.

At step 302, the identification server 60 processes each communication to determine a person who is the subject of the communication (e.g., recipient of the communication) and a name or names (e.g., nicknames) associated with that person in the communication. In embodiments, the connection module 71 of the identification server 60 processes communications data received at step 300 continuously or periodically to determine a person (subject) referenced in a communication and the name or names associated with the person being referenced. For example, the identification server 60 may determine that a communication from Jane Doe to John Doe includes a greeting to “Johnny”. In this example, the identification server 60 recognizes the subject of the communication as John Doe and also recognizes that the nickname “Johnny” is associated with the subject of the communication (John Doe).

In embodiments the NLP module 75 is utilized to search communication data gathered at step 300 for names (e.g., proper names) used in a context, such that the name may be applied to a specific person (e.g., contact), such as the person being talked to. For example, the NLP module 75 may utilize classification techniques to find the use of names in subject/predicate/object settings within a communication. In embodiments, the identification server 60 determines a speaker (in a communication) through metadata tagged to a statement. For example, if an instant message from Jane Doe to John Doe reads: “Hey Johnny, thanks for doing the extra work”, then the identification server 60 may understand that Jane Doe is talking to John Doe and is calling him Johnny.

At step 303, the identification server 60 associates or maps, for each communication, the one or more names associated with the person (subject) in the communication determined at step 302 with contacts stored in the knowledge database 74. In embodiments, the connection module 71 of the identification server 60 maps the name or names determined at step 302 with contacts stored in the knowledge database 74 for each participant. In embodiments, the identification server 60 also records instances of occurrences (e.g., “counts”) of each name (e.g., informal name) in order to provide information regarding the percentage of usage of each name. For example, at step 303, the identification server 60 may associate the nickname “Johnny” determined at step 302 with the contact name “John S. Doe” stored in the knowledge database 74. In this example, the nickname “Johnny” has already been recorded in a table, and the identification server 60 updates the instances of occurrence of the nickname “Johnny” to reflect the fact that the nickname “Johnny” was associated with “John S. Doe” in multiple communications. In this way, the knowledge database 74 can provide “counts” of occurrences for use in determining percentages of occurrences of names.

Table 1 illustrates a data store of associations for a participant Richard Roe created in accordance with steps 300-303 of FIG. 3. It should be understood that Table 1 is provided for illustrative purposes, and the exact structure of any data table utilized with the present invention may vary.

TABLE 1
Exemplary data store of associations for a first participant Richard Roe.
Richard Roe's Email Contacts

| | | Subject Name | Informal Name | |
|---|---|---|---|---|
| | | (formal name | (e.g., nickname | |
| | Contact Name | of people | of people | |
| | (Richard Roe's | communicated | communicated | |
| Row | Contacts) | with) | with) | Count |
| 1 | Jane Doe | John S. Doe | John Doe | 5 |
| 2 | Jane Doe | John S. Doe | Johnny | 30 |
| 3 | Jane Doe | John S. Doe | Doe Man | 5 |
| 4 | Jane Doe | Joe M. Bloggs | Joey | 18 |
| 5 | Jane Doe | Joe M. Bloggs | Joe Bloggs | 10 |
| 6 | Jane Doe | Joe M. Bloggs | Blogger | 6 |

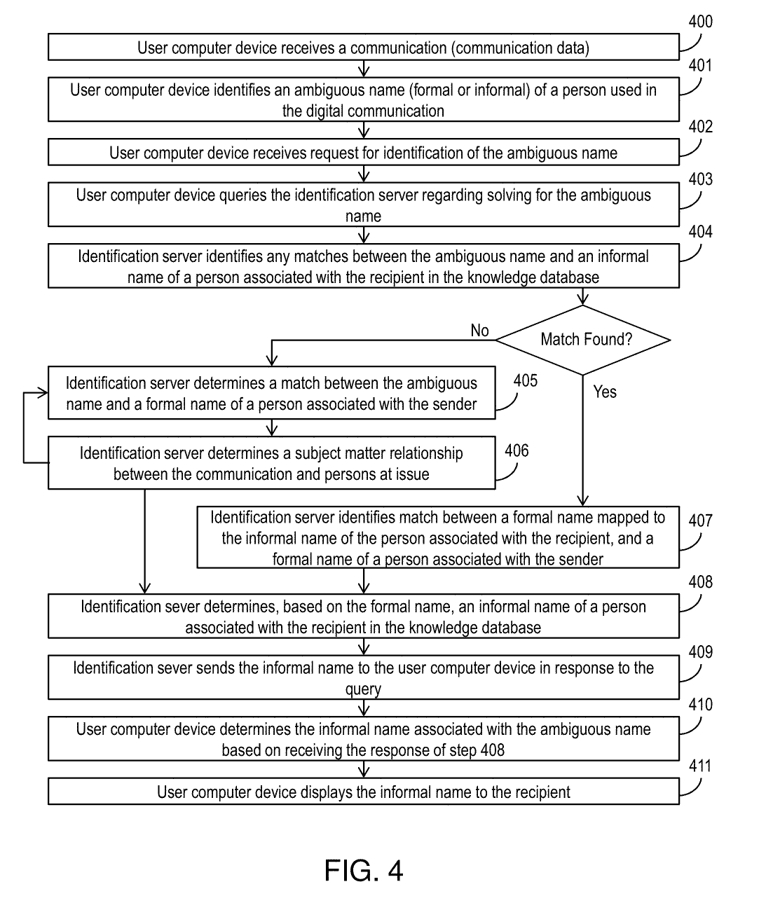

In embodiments, the name-to-nickname reference entities in a participant database (e.g., 72, 73) relate all connection names to the people that a participant communicates with and the names the participant calls those people. Each connection has a number of names he or she has called out, and each of these names is stored as a relational subject to that connection. For example, with reference to Table 1, information regarding Richard Roe's connection “Jane Doe” is stored in the knowledge database 74, including a separate row containing: attributes for contact name (e.g., formal name of contact); subject name (e.g., formal name of person Jane Doe has communicated with); informal name (e.g., nickname of the person communicated with); and count (e.g., number of times the name is referenced over multiple communications). In embodiments, a participant database (e.g., 72, 73) developed for each participant contains information pertaining to the owning participant (a participant's connections and name mapping's for those connections). In embodiments, the participant's specific database (e.g., 72, 73) that is queried as detailed in FIG. 4 below, does not contain information on any more than the connections that apply to the owning participant.

At step 304, the identification server 60 determines subject matter category relationships between participants and contacts and stores subject matter relationship data in the knowledge database 74. In embodiments, a related database table is created by the identification server 60, which contains information as to the subject areas that each referenced person might be aware of and possibly work with others on. In aspects, the context module 76 of the identification server 60 associates the subject (e.g., a person receiving the communication) of each communication received at step 300 with context data derived from the communication, such as the subject matter of the communication.

Table 2 illustrates an exemplary subject matter relationship table created in accordance with steps of FIG. 3. In Table 2, it can be seen that Richard Roa relates to Jane Doe, John S. Doe and Joe M. Bloggs for the subject matter “patents”. It can be further seen that Richard Roa does not relate to another person on the subject matter “juggling” (wherein “null” indicates that the subject does not apply to a specific person).

TABLE 2
Exemplary subject matter relationship database.

| Row | Person | Subject | User related back to |
|---|---|---|---|
| 1 | Richard Roe | patents | Jane Doe |
| 2 | Richard Roe | patents | John S. Doe |
| 3 | Richard Roe | patents | Joe M. Bloggs |
| 4 | Richard Roe | juggling | Null |

It should be understood that the knowledge database 74 can be developed and grown over time based on the ongoing collection and processing of communications data in accordance with steps 300-304. Therefore, the list of names, nicknames, subject matter relationship data and the appropriate counts may be continuously updated. With the method of FIG. 3, the knowledge database 74 can be populated with sender context data, recipient context data, and shared relationship data.

FIG. 4 shows a flowchart of a method in accordance with aspects of the invention. Steps of the method of FIG. 4 may be performed in the environment illustrated in FIG. 2, and are described with reference to elements shown in FIG. 2. For ease of reference, the steps of FIG. 4 will be discussed with reference to the user computer device 62.

At step 400, the user computer device 62 receives a communication (communication data). The communication data received at step 400 may be electronic communication data (e-communication data) in the form of an email, text message, instant message, social network message, telephone call (or other sound messages), images, etc. In the case of sound messages, the user computer device 62 may include speech recognition software to convert sound messages into text based messages. Likewise, in the case of image messages, the user computer device 62 may include text recognition software to recognize and convert images into text based messages.

At step 401, the user computer device 62 identifies a name of a person used in the communication received at step 400. Step 401 may be performed in real-time as the communication is received or being received. In aspects, the processing module 92 identifies an ambiguous name of a person (e.g., informal name) used in the communication. In embodiments, the processing module 92 utilizes NLP to find the use of names (e.g., ambiguous names) within any text data associated with the communication (e.g., the text-based data of a text-based communication or the text-based data determined from sound or image communications). Conventional data processing techniques may be utilized to determine the presence of an ambiguous name in accordance with step 401. In aspects, the processing module 92 determines that text of a communication includes an ambiguous name by comparing the text to a stored database of words.

At step 402, the user computer device 62 receives a request for identification of an ambiguous name in the communication received at step 400. In embodiments, the system 50 will enable a participant to solve ambiguity only upon request. For example, a user may select (e.g., right click) on an ambiguous name reference in the communication received at step 400 in order to bring up menu of options regarding solving for the ambiguous name (determining whom the ambiguous name is referencing). In aspects, the user computer device 62 receives a selection of a menu option from a user (such was when the user clicks on the menu option), wherein the received selection is the request for identification of an ambiguous name identified at step 401. Alternatively, the system 50 may automatically solve for ambiguity of a person's name.

At step 403, the user computer device 62 queries the identification server 60 regarding solving for the ambiguous name identified at step 401. This query may be sent from the user computer device 62 automatically upon detection of the ambiguous name, or upon receipt of a request from the user at step 402.

At step 404, the identification server 60 identifies any matches between the ambiguous name in the communication received at step 400 and any informal names of persons associated with the recipient in the knowledge database 74 (i.e., informal names in the recipient's data). In embodiments, the match at step 404 is further performed based on the type of medium of the communication (e.g., email or text message or social media). For example, matches may only be made between an ambiguous name in an email communication and an informal name in the recipient's data associated with email communications. In one example, a recipient receives an email message “Johnny wants to talk to you” from a sender. The identification server 60 identifies a match between the ambiguous name “Johnny” and two references to the informal name “Johnny” stored in the first participant database 72 of the recipient in accordance with step 404. The recipient has two connections associated with the informal name “Johnny” stored in the knowledge database 74, and is not sure which person (formal names of: John Smith or John S. Doe) is being referenced in the message.

At step 407, if a match is found at 404, the identification server 60 identifies a formal name associated with the informal name in the recipient data (in the knowledge database 74), and matches the formal name associated with the recipient data with a formal name of a person in the sender data (in the knowledge database 74). For example, the identification server 60 determines that the informal name “Johnny” is associated with the formal names “John Smith” and “John S. Doe” in the recipient data, and that only formal name “John S. Doe” is also present in the sender data. In this case there is a high probability that the “Johnny” referenced in the communication is “John S. Doe” due to the fact that “John S. Doe” is the common denominator between the sender data and the receiver data.

If no match is found at step 404, at step 405, the identification server 60 determines a match between the ambiguous name and a formal name of a person associated with the sender of the communication received at step 400. In embodiments, the connection module 71 determines the match in accordance with step 405. By way of example, the connection module 71 may determine that the nickname “Johnny” is associated with the formal name “John S. Doe” in data columns associated with the sender in the knowledge database 74.

At step 406, the identification server 60 determines a subject matter relationship between the subject matter of the communication received at step 400 and participants to narrow down possible matches at step 405. For example, if the subject of the communication received at step 400 is “patents”, and the identification server 60 determines a match between “Johnny” and multiple formal names associated with the sender, then the identification server 60 may utilize a subject matter relationship database (such as the one exemplified in Table 2 above) to determine that Richard Roe and John S. Doe have communicated in the past about the subject “patents”, thereby indicating that the formal name that should be associated with “Johnny” is “John S. Doe”. In embodiments, the system 50 can cycle through all possible subjects of the communication received at step 400 any desired number of times to obtain, with confidence, a match in accordance with step 405. In other words, steps 405-406 may be repeated as necessary to determine, within an acceptable probability, the match at step 405.

In embodiments the identification server 60 also identifies a probability associated with a match at step 404 or 405. For example, the user computer device 62 may query the identification server 60 regarding the ambiguous name “Johnny” at step 403, and the identification server 60 may identify a match between the ambiguous name “Johnny” and the formal name “John S. Doe” in the sender's participant database (e.g., 72), with a 90% probability (e.g., 90% probability that the communication received at step 400 is referring to John S. Doe based on count data collected in the knowledge database 74). The identification server 60 may determine that a match is found only if the probability that the match is correct meets a predetermined threshold.

At step 408, the identification server 60 determines, based on the formal name associated with the sender identified at steps 405 or 407, an informal name (a non-ambiguous name) in the recipient data within the knowledge database 74. For example, the identification server 60 may determine that the formal name “John S. Doe” is associated with the informal name “John Doe” within data columns associated with the recipient in the knowledge database 74. In embodiments, the connection module 71 of the identification server 60 determines the informal name from columns of the knowledge database 74 associated with the recipient.

In embodiments, the identification server 60 determines a likelihood or probability that the informal name identified at steps 405 or 407 is associated with the ambiguous name identified at step 401. In aspects, the determination is made based on the “count” indicating the number of times the informal name associated with the formal name is utilized in past communications between a recipient and a sender. In embodiments, the determination is further made based on the medium by which the communication was made. For example, the identification server 60 may determine that, for Richard Roe's contacts through email, the ambiguous name “Johnny” has been used 75% of the time in communications between Jane Doe and John S. Doe.

At step 409, the identification server 60 sends the informal name determined at step 407 to the user computer device in response to (as an answer to) the query of step 403. In embodiments, the identification server 60 sends in the informal name in real time in response to the query of step 403.

At step 410, the user computer device 62 determines the informal name associated with the ambiguous name based on receiving the response of step 408. In embodiments, the processing module 92 of the user computer device 62 receives the response from the identification server 60 via the network 55.

At step 411, the user computer device 62 displays the informal name (i.e., non-ambiguous name) to the communication recipient. In embodiments, a participant may be enabled to configure user computer device 62 such that any ambiguously referenced person (e.g., a name that is not a formal name) is always solved. In this case, a pop-up notification may appear with the solution to the ambiguously referenced person (i.e., informal name of the referenced person). Alternatively, the ambiguous reference to a person in a communication may be automatically replaced with the informal name of the person or may be automatically displayed with the informal name of the person in parenthesis next to the ambiguous reference. For example, the system 50 may automatically replace a first nickname of a sender (ambiguous reference) with a second nickname of the sender that is known to the recipient.

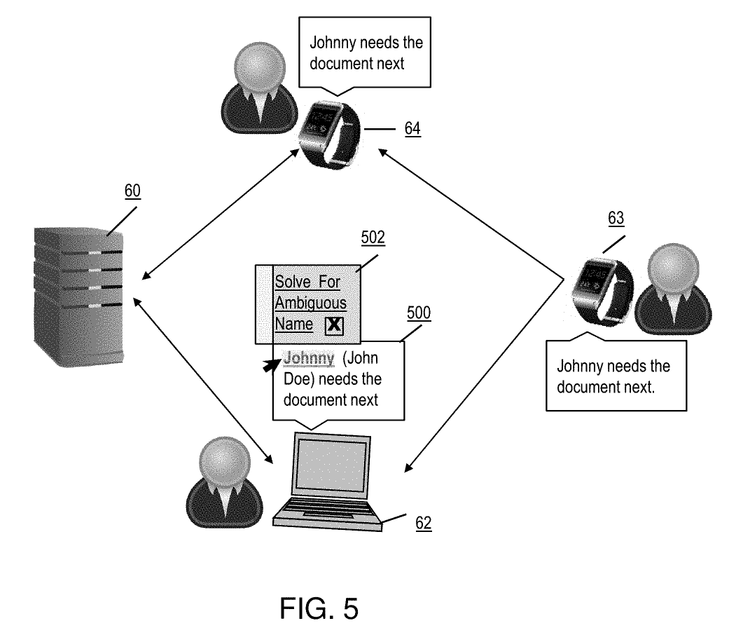

FIG. 5 illustrates an exemplary use scenario according to embodiments of the present invention. The use scenario of FIG. 5 may be performed in the environment illustrated in FIG. 2, and is described with reference to elements shown in FIG. 2.

As illustrated in FIG. 5, a first recipient, Richard Roe (recipient) receives a group message 500 at the user computer device 62 from Jane Doe's user computer device 63, stating “Johnny needs the document next”, in accordance with step 400 of FIG. 4. The user computer device 62 identifies the ambiguous name “Johnny”, in accordance with step 401 of FIG. 4 using natural language processing and a database (internal or external) of words and names. Richard is not sure whom Jane is referring to when he reads the message 500. Richard right clicks on the name “Johnny”, and a window 502 pops up giving him the option to select to solve for an ambiguous name (i.e. request identification of the ambiguous name). The user computer device 62 receives the request for identification of the ambiguous name in accordance with step 402 of FIG. 4, and contacts the identification server 60 with a request to identify the ambiguous name “Johnny” in accordance with step 403 of FIG. 4. The identification server 60 determines that no matches exist in the first participant database 72 (recipient database) between the ambiguous name “Johnny” and informal names of persons associated with the recipient, in accordance with step 404 of FIG. 4.

The identification server 60 then determines a match between the ambiguous name “Johnny” and two formal names including “John Smith” and “John S. Doe” in columns of the second participant database 73 (associated with the sender Jane), in accordance with step 405 of FIG. 4. In order to solve the ambiguity remaining, the identification server 60 determines that the communication includes the subject matter of “patents”, utilizing NLP processing. The identification server 60 then determines that the person “John S. Doe” is associated with the subject matter “patents” in a subject matter relationship database in the knowledge database 74. Accordingly, the identification server 60 determines that there is a subject matter relationship between the communication and “John S. Doe” in accordance with step 406, and the match between the ambiguous name “Johnny” is determined to be the formal name “John S. Doe”, in accordance with step 405.

In this use scenario, the identification server 60 then determines, based on the formal name “John S. Doe”, an informal name of “John Doe” in columns of the first participant database 72 (recipient database), in accordance with step 408. The identification server 60 then sends the informal name “John Doe” to the user computer device 62 of Richard in accordance with step 409, and the user computer device determines that the informal name “John Doe” is associated with the ambiguous name “Johnny” based on the received data, in accordance with step 410. The user computer device 62 then displays the informal name to Richard in accordance with step 411 of FIG. 4. In this example, the informal name “John Doe” is depicted in parenthesis next to the ambiguous name “Johnny”.

In this example, a second recipient receives the message from Jane at the user computer device 64 in accordance with step 400 of FIG. 4. The user computer device 64 identifies an ambiguous name “Johnny” in accordance with step 401 of FIG. 4. In this case, the user computer device 64 is set to automatically solve for ambiguous names. The user computer device 64 does not identify any matches in accordance with step 404. Moreover, the user computer device 64 does not determine an informal name in accordance with step 408, since the second recipient does not know John S. Doe. In other words, the second recipient's data within the knowledge database 74 does not include anyone by the name of John S. Doe, and therefore does not include any information regarding informal or formal names of John S. Doe. Accordingly, the user computer device 64 does not determine any informal name in accordance with step 408 of FIG. 4, the identification process ends, and the second recipient does not receive any solution to the ambiguous name “Johnny”.

In embodiments, the present invention provides a method for identifying a word (name) with multiple spellings by the identification server 60 first identifying (e.g., receiving) multiple past communication between a user and a first individual (email, phone, social media, etc.), in accordance with step 300 of FIG. 3. Next, the identification server 60 identifies how the user utilizes the first individual's name in each instance and within each medium (email, phone, social media, etc.) in accordance with step 302 of FIG. 3, and maps the information in accordance with step 303 of FIG. 3. Upon receipt of a new communication at step 400 of FIG. 4, the user computer device (e.g., 62) identifies the current setting (automatically solve for ambiguous name or solve for ambiguous name upon request) and medium (email, phone, social media, etc.) of the new communication. The user computer device (e.g., 62) then determines the likely use of the first individual's name based upon the past communications and the current setting and medium through the knowledge database 74 of the identification server 60. See step 410 of FIG. 4. The user computer device (e.g., 62) then reviews the current communication to supplement the communication with the first individual's identity.

In embodiments, the identification server 60 identifies multiple past communications between a second individual; identifies how the user utilizes the second individual's name in each instance within each medium when engaged in communication between the first individual and the second individual; and determines the likely use of the first and the second individuals name based on the past communication. The identification server 60 may further review the current communication to supplement the communication data with the first and second individuals identity.

In embodiments, a computer-implemented method comprises: receiving, by a first computing device, a digital communication from a second computing device; identifying, by the first computing device, an ambiguous name of a person referenced in the digital communication; automatically sending, by the first computing device, a query to a remote identification server regarding solving for the ambiguous name; receiving, by the first computing device, a response to the query from the remote identification server; and displaying, by the first computing device, a non-ambiguous name based on the response to the query. In aspects, the displaying comprises automatically updating the digital communication displayed by the first computing device to include the non-ambiguous name.

Advantageously, embodiments of the system 50 are configured to process and understand how to narrow down possible reference points through further classification in order to understand the context in which a person is speaking to the recipient (e.g., if Richard is talking about Jane and the context is writing patents, that narrows down the relevant participants to Jane Doe). Thus, embodiments of system 50 are contextually aware through: NLP processing in the cyclical process of FIG. 3; and the real time contextual application of FIG. 4 (e.g., knowing from context which “John” the writer is talking about).

In embodiments, a service provider could offer to perform the processes described herein. In this case, the service provider can create, maintain, deploy, support, etc., the computer infrastructure that performs the process steps of the invention for one or more customers. These customers may be, for example, any business that uses electronic communications technology. In return, the service provider can receive payment from the customer(s) under a subscription and/or fee agreement and/or the service provider can receive payment from the sale of advertising content to one or more third parties.

In still another embodiment, the invention provides a computer-implemented method for identifying the subject of an ambiguous name in a communication. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computing device, historic communication data of a first person from a first remote computing device;
receiving, by the computing device, historic communication data of a second person from a second remote computing device;
generating, by the computing device, a knowledge database comprising contact data for both the first person and the second person mapped to third party data, including informal and formal names of one or more third parties referenced in the historic communication data of the first person and the historic communication data of the second person;
receiving, by the computing device, a query regarding an ambiguous name referenced in a new communication between the first person and the second person; and
determining, by the computing device, a match between the ambiguous name and an informal name or a formal name in the knowledge database.

2. The method of claim 1, wherein the determining the match between the ambiguous name and an informal name or a formal name in the knowledge database further comprises determining the match based on a medium of the new communication.

3. The method of claim 2, wherein the medium of the new communication is selected from the group consisting of: email, text messaging, instant messaging, audio communication, and picture-based communication.

4. The method of claim 1, wherein the first person is a sender of the new communication and the second person is a recipient of the new communication, the method further comprising: sending, by the computing device, the informal or formal names matched to the ambiguous name to the second remote computing device.

5. The method of claim 1, wherein the knowledge database further comprises counts indicating a number of times the informal names of the one or more third parties were utilized in the historic communications.

6. The method of claim 1, wherein:
the first person is a sender of the new communication and the second person is a recipient of the new communication; and
the determining the match between the ambiguous name and an informal name or a formal name in the knowledge database comprises:
determining, by the computing device, a match between the ambiguous name and the informal name of a contact of the recipient; and
identifying, by the computing device, a match between a formal name mapped to the informal name of the contact of the recipient, and a formal name of a contact of the sender.

7. The method of claim 6, further comprising:
determining, by the computing device, an informal name of a contact of the recipient's based on the formal name of the contact of the sender; and
sending, by the computing device, the informal name to the second remote computing device as an answer to the query.

8. The method of claim 1, wherein:
the first person is a sender of the new communication and the second person is a recipient of the new communication; and
the determining the match between the ambiguous name and an informal name or a formal name in the knowledge database comprises:
determining, by the computing device, a match between the ambiguous name and the formal name associated with a contact of the sender; and
determining, by the computing device, an informal name associated with a contact of the recipient based on the formal name; and
sending, by the computing device, the informal name to the second remote computing device as an answer to the query.

9. The method of claim 8, wherein the knowledge database further includes a subject matter category mapped to the formal name, the method further comprising: determining, by the computing device, a match between a subject of the new communication and the subject matter category mapped to the formal name.

10. A computer program product for identifying a subject of an ambiguous name in a communication, the computer program product comprising a computer readable storage medium having program instructions embodied therewith, the program instructions executable by a computing device to cause the computing device to:
receive historic communication data of a first person from a first remote computing device;
receive historic communication data of a second person from a second remote computing device;
generate a knowledge database comprising contact data for both the first person and the second person mapped to third party data, including informal and formal names of one or more third parties referenced in the historic communication data of the first person and the historic communication data of the second person;
receive a query regarding an ambiguous name referenced in a new communication between the first person and the second person; determine a match between the ambiguous name and a formal name associated with a contact of the sender; and
send an answer to the query identifying the subject of the ambiguous name.

11. The computer program product of claim 10, wherein each of the first and second data sets further comprise counts indicating a number of times the informal names of the contacts of the respective first person and second person were utilized in the respective historic communication data.

12. The computer program product of claim 10, wherein the determining the match between the ambiguous name and the formal name is based on the counts.

13. The computer program product of claim 10, wherein the first person is a sender of the new communication and the second person is a recipient of the new communication; and wherein the program instructions executable by the computing device further cause the computing device to:
determine an informal name associated with a contact of the recipient based on the formal name; wherein sending the answer to the query comprises sending the informal name to the second remote computing device.

14. The computer program product of claim 13, wherein the knowledge database further includes a subject matter category mapped to the formal name, and the program instructions executable by the computing device further cause the computing device to:
determine a match between a subject of the new communication and the subject matter category mapped to the formal name.

15. A system for identifying a subject of an ambiguous name in a communication, comprising:
a CPU, a computer readable memory and a computer readable storage medium associated with a computing device;
program instructions to receive historic communication data of a first person and historic communication data of a second person;
program instructions to generate a knowledge database from the received historic communication data of the first person and the received historic communication data of the second person, the knowledge database including a first data set comprising contacts of the first person mapped to formal names and informal names of one or more third parties, as well as counts of the occurrences of the informal names in the historic communications, and a second data set comprising contacts of the second person mapped to formal names and informal names of one or more third parties, as well as counts of the occurrences of the informal names in the historic communications; and
program instructions to receive a query from a recipient of a new communication to identify a third person who is a subject of an ambiguous name referenced in the new communication;
program instructions to determine a formal name or an informal name of the third person who is a subject of the ambiguous name using the first data set and the second data set, wherein the determination is made based in part on the counts; and
program instructions to send the formal name or the informal name of the third person to a computing device of the recipient of the new communication in response to the query;
wherein the program instructions are stored on the computer readable storage medium for execution by the CPU via the computer readable memory.

16. The system of claim 15, wherein the first person is a sender of the new communication and the second person is a recipient of the new communication; and wherein the system further comprises:
program instructions to determine a match between the ambiguous name and the informal name of a contact in the second data set of the recipient;
program instructions to identify a match between a formal name mapped to the informal name of the contact in the second data set of the recipient, and a formal name of a contact in the first data set of the sender; and
program instructions to determine an informal name in the second data set of the recipient mapped to the formal name; wherein the program instructions to send the formal name or the informal name of the third person to the computing device of the recipient of the new communication comprise program instructions to send the informal name.

17. The system of claim 15, wherein the first person is a sender of the new communication and the second person is a recipient of the new communication, and wherein the system further comprises:
program instructions to determine a match between the ambiguous name and the formal name of a contact in the first data set of the sender; and
program instructions to determine an informal name mapped to the formal name in the second data set of the recipient, wherein the sending the formal name or the informal name of the third person to the computing device of the recipient comprises sending the informal name mapped to the formal name in the second data set of the recipient.

18. The system of claim 17, wherein the knowledge database further includes a subject matter category mapped to the third person, and the system further comprises: program instructions to determine a match between a subject of the new communication and the subject matter category mapped to the third person.

19. The system of claim 18, further comprising: program instructions to determine a match between a second subject of the new communication between the first person and the second person and a second subject matter category mapped to the third person in the knowledge database.

20. The system of claim 15, further comprising: program instructions to determine the formal name or the informal name of the third person based on the medium of the new communication.
